(19) United States
(12) Patent Application Publication
(10) Pub. No.: US 2014/0185779 A1
(43) Pub. Date: Jul. 3, 2014

(54) STRUCTURE AND RESIN STRUCTURE MANUFACTURING METHOD, STRUCTURE, AND X-RAY IMAGING APPARATUS INCLUDING STRUCTURE

(71) Applicant: CANON KABUSHIKI KAISHA, Tokyo (JP)

(72) Inventor: Takayuki Teshima, Yokohama-shi (JP)

(73) Assignee: CANON KABUSHIKI KAISHA, Tokyo (JP)

(21) Appl. No.: 14/137,780

(22) Filed: Dec. 20, 2013

(30) Foreign Application Priority Data
Dec. 27, 2012 (JP) 2012-284433
Oct. 9, 2013 (JP) 2013-212296

(51) Int. Cl. G01N 23/04; B32B 3/30; B32B 15/00

(52) U.S. Cl. CPC G01N 23/04; B32B 15/00; B32B 3/30
USPC 378/145; 428/457; 428/172; 264/259

(57) ABSTRACT

A resin structure manufacturing method includes filling a mold with a resin, fixing a first supporting substrate onto the resin filled in the mold, hardening the resin filled in the mold, fixing a second supporting substrate onto the first supporting substrate, demolding the resin from the mold using the second supporting substrate, and separating the first supporting substrate and the second supporting substrate after demolding.

### BACKGROUND OF THE INVENTION

1. Field of the Invention

The present invention relates to a structure and resin structure manufacturing method, a structure, and an X-ray imaging apparatus including the structure.

2. Description of the Related Art

A diffraction grating made up of a structure having a periodical structure is employed for various devices as a spectroscopic element. In particular, a structure formed of a metal having high X-ray absorptivity is employed for nondestructive inspection of objects serving as X-ray shield grating, and in the field of medicine.

An imaging apparatus configured to implement an imaging method employing X-ray Talbot interference (X-ray Talbot interference method) is one application of the X-ray shield grating.

The X-ray Talbot interference method will be briefly described. The X-ray Talbot interference method is one imaging method (X-ray phase imaging method) employing X-ray phase contrast.

A common imaging apparatus configured to implement the X-ray Talbot interference method forms an interference pattern by a spatially coherent X-ray passing through a subject and a diffraction grating configured to diffract X-rays. The X-ray shield grating (hereinafter, also simply referred to as “shield grating”) configured to periodically shield X-rays is disposed in a position where the interference pattern thereof is formed, thereby forming moire. This moire is detected by a detector, and detection results thereof are used to obtain information of the subject (in general, information of X-ray phase change according to the subject, information of X-ray scattering according to the subject, etc.).

A common shield grating employed for the Talbot interference method has a structure where X-ray transmitting portions (hereinafter, also simply referred to as “transmission portions”) and X-ray shielding portions (hereinafter, also simply referred to as “shielding portions”) are periodically arrayed. The shielding portions are made of a metal having high X-ray absorptivity, such as gold for example, and are often formed having a structure of which the aspect ratio is high (the aspect ratio is a ratio between the height or depth h and lateral width w of a structure (h/w). Note that “height” or “depth” used here may also be described as “thickness of shielding portion in X-ray travelling direction”). A planar shield grating is effective in the case of handling parallel light (parallel X-rays) such as at synchrotron radiation facilities. However, imaging employing an X-ray source has a problem in that as the shielding portion is distanced from the optical axis (X-ray axis), the travelling direction of the X-rays and the height direction of the shielding portion shift out of alignment. This X-ray source is a point light source configured to emit divergent light (divergent X-rays), such as an X-ray tube in a lab. Such imaging has a problem in that the X-rays intended to transmit the shield grating are also shielded, which may prevent sufficient X-ray transmission contrast from being obtained, or decrease the X-ray dosage arriving at the detector. This may lead to increased noise in information of the subject at peripheral regions distant from the optical axis, and it may be difficult to obtain information of the subject itself. Therefore, in order to reduce misalignment between the travelling direction of the X-ray and the height direction of the shielding portion, the grating is preferably curved to obtain a shape following the wavefront of the divergent X-ray.

Therefore, Japanese Patent Laid-Open No. 2007-206075 (corresponding US is 2007/0183583) discloses a method wherein a shield grating is sealed in a vacuum chamber employing a circular enclosure, and two-dimensionally curved by pressure difference so as to have a spherical segment shape, whereby the height direction of the shielding portion and the travelling direction of X-rays are made to match.

### SUMMARY OF THE INVENTION

A resin structure manufacturing method according to an embodiment of the present invention includes filling a mold with a resin, fixing a first supporting substrate onto the resin filled in the mold, hardening the resin filled in the mold, fixing a second supporting substrate onto the first supporting substrate, demolding the resin from the mold using the second supporting substrate, and separating the first supporting substrate and the second supporting substrate after demolding.

Further features of the present invention will become apparent from the following description of exemplary embodiments with reference to the attached drawings.

### BRIEF DESCRIPTION OF THE DRAWINGS

FIG. 1A is a process diagram for describing a first embodiment of the present invention and a first exemplary embodiment.

FIG. 1B is a process diagram for describing the first embodiment of the present invention and the first exemplary embodiment.

FIG. 1C is a process diagram for describing the first embodiment of the present invention and the first exemplary embodiment.

FIG. 1D is a process diagram for describing the first embodiment of the present invention and the first exemplary embodiment.

FIG. 1E is a process diagram for describing the first embodiment of the present invention and the first exemplary embodiment.

FIG. 1F is a process diagram for describing the first embodiment of the present invention and the first exemplary embodiment.

FIG. 2A is a process diagram for describing a second embodiment of the present invention and a second exemplary embodiment.

FIG. 2B is a process diagram for describing the second embodiment of the present invention and the second exemplary embodiment.

FIG. 2C is a process diagram for describing the second embodiment of the present invention and the second exemplary embodiment.

FIG. 2D is a process diagram for describing the second embodiment of the present invention and the second exemplary embodiment.

FIG. 2E is a process diagram for describing the second embodiment of the present invention and the second exemplary embodiment.

FIG. 2F is a process diagram for describing the second embodiment of the present invention and the second exemplary embodiment.

FIG. 3A is a process diagram for describing a first comparative example of the present invention.

FIG. 3B is a process diagram for describing the first comparative example of the present invention.

FIG. 3C is a process diagram for describing the first comparative example of the present invention.

FIG. 4 is a graph illustrating the relationship between the thickness of a quartz substrate and x-ray transmittance.

FIG. 5A is a diagram for describing a third embodiment of the present invention and a third exemplary embodiment.

FIG. 5B is a diagram for describing the third embodiment of the present invention.

FIG. 5C is a diagram for describing the third embodiment of the present invention.

FIG. 5d is a diagram for describing the third embodiment of the present invention and a fourth exemplary embodiment.

FIG. 5E is a diagram for describing the third embodiment of the present invention and a fifth exemplary embodiment.

### DESCRIPTION OF THE EMBODIMENTS

In order for a shield grating to maintain a curved shape using the method disclosed in Japanese Patent Laid-Open No. 2007-206075, pressure difference has to continuously be applied to the grating. Accordingly, maintenance of the curved shape may be difficult. This is also true regarding structures other than gratings. Accordingly, description will be made in detail with reference to the drawings, regarding a structure capable of maintaining a curved shape without pressure being continuously applied thereto and a resin structure manufacturing method used for manufacturing the structure, a structure manufactured by this manufacturing method, and an X-ray imaging apparatus including the structure.

### First Embodiment

In the following description of the present embodiment, an X-ray shield grating used in the X-ray Talbot interference method will be exemplified as the structure manufactured by the manufacturing method. Note however, that the present embodiment may also be applied to a manufacturing method of a structure used for other applications. The X-ray shield grating manufactured by the present embodiment includes a metal structure portion and a resin structure portion. The metal structure portion includes metal shielding portions and transmitting portions, which are arrayed. The resin structure portion includes a resin having a curved shape and a supporting substrate. The metal structure portion is fixed onto the resin having the curved shape, whereby the metal structure portion can maintain the curved shape.

The resin having the curved shape can be manufactured by molding a resin using a mold. The resin may be molded using the mold by filling the resin in the mold, and demolding the resin from the mold after hardening the resin. Fixing the supporting substrate to the resin filled in the mold enables the resin to be demolded using this supporting substrate at the time of demolding. Demolding the resin from the mold using the supporting substrate applies force to the supporting substrate. Therefore, if the bending strength of the supporting substrate is low, demolding may be difficult due to the supporting substrate being damaged at the time of demolding. On the other hand, in the case of a supporting substrate having strong bending strength, the X-ray transmittance is generally low. Accordingly, the X-ray transmittance at the transmitting portions of the X-ray shield grating deteriorates when employing the supporting substrate having strong bending strength. Note that the bending strength mentioned here means the maximum fiber stress exhibited before cracking, damage, or fracturing is observed in a bending test.

In the present embodiment, the resin is demolded from the mold using a first supporting substrate having high X-ray transmittance, and a second supporting substrate having strong bending strength. Next, the first supporting substrate and second supporting substrate after demolding the resin from the mold are separated. Thus, deterioration in X-ray transmittance at the transmitting portions of the X-ray shield grating can be suppressed while maintaining the bending strength of the supporting substrate (supporting substrate of the first and second supporting substrates combined) at the time of demolding. The X-ray transmittance of the first supporting substrate can be decided taking into consideration around what level is going to be set as the smallest level for X-ray transmittance of the transmitting portions of the shield grating, and the level the X-ray transmittance of the resin. Also, the bending strengths of the first supporting substrate and second supporting substrate can be decided depending on around what level of force will be applied to the supporting substrates at the time of demolding of the resin from the mold. For example, in the case of coating a releasing agent over the mold before filling the resin in the mold, substrates having smaller bending strength can be employed as the first supporting substrate and second supporting substrate, as compared to a case of coating no releasing agent over the mold.

Also, the resin structure manufactured according to the present embodiment is not restricted to a structure used for manufacturing of the structure according to the present embodiment (structure including the resin structure, supporting substrates, and metal structure). For example, molding the resin so as to serve as a microlens, a diffraction optical element, and an antireflection structure, enables a resin structure, where these are formed on the first supporting substrate having high X-ray transmittance, to be manufactured. Also, a first supporting substrate having high optical transmittance may also be employed instead of the first supporting substrate having high X-ray transmittance.

The resin structure manufacturing method according to the present embodiment includes the following processes.
(1) First Process: process to fill the resin in the mold. This is a process to fill the resin to be molded in the mold at the time of molding a resin structure reflecting the shape of the mold.
(2) Second Process: process to fix the first supporting substrate onto the filled resin. The first supporting substrate is fixed by being demolded in a manner integral with the resin molded with the mold.
(3) Third Process: process to harden the resin filled in the mold.
(4) Fourth Process: process to fix the second supporting substrate onto the first supporting substrate. A method of fixing will be described later.
(5) Fifth Process: process to demold the resin filled in the mold from the mold using the second supporting substrate. The second supporting substrate does not have to be employed directly.
(6) Sixth Process: process to separate the first supporting substrate and second supporting substrate after demolding. According to this process, a resin structure is obtained wherein the resin reflecting the shape of the mold is formed on the first supporting substrate.

Note that the first to sixth processes may be performed without being restricted to this order. For example, the third process to harden the resin has to be performed prior to the fifth process to demold the resin from the mold, but may be performed after the fourth process, or may be performed prior to the second process. Also, for example, the second process to fix the first supporting substrate onto the resin may be performed after performing the fourth process to fix the second supporting substrate onto the first supporting substrate.

The X-ray shield grating manufacturing method according to the present embodiment includes a seventh process to fix the metal structure portion to the resin of the resin structure portion manufactured in the first to fifth processes described above. In the present embodiment, the metal structure portion is fixed onto the curved shape that the resin has. Thus, the metal structure portion has the curved shape reflecting the shape of the resin. At this time, the transmitting portions in the metal structure portion are directed in the normal direction of the face of the curved shape of the resin structure portion.

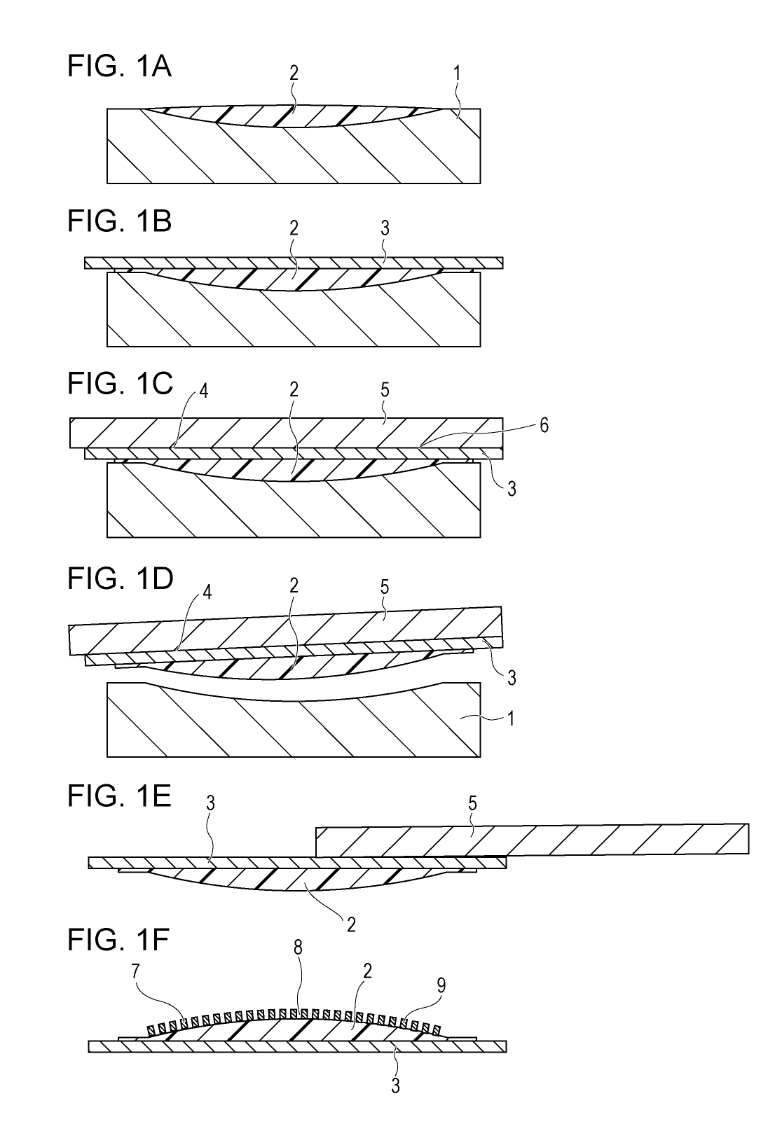

Hereinafter, the processes of the X-ray shield grating manufacturing method will be described in detail with reference to FIGS. 1A to 1F.

### First Process

First, description will be made regarding the first process to fill a resin 2 in a mold 1 illustrated in FIG. 1A. The present embodiment employs a mold in which a recessed portion is formed. However, the mold 1 which can be employed in the present embodiment is not restricted to the mold 1 in which a recessed portion is formed. Accordingly, a mold in which a protruding portion or both of a protruding portion and a recessed portion are formed may also be employed. When employing the mold 1 according to the present embodiment, the resin 2 molded by the mold 1 is molded in a protruding shape reflecting the recessed portion shape of the mold 1. For example, when employing a mold 1 having a spherical recessed portion formed, the resin 2 is molded into a spherical protruding portion, and when employing a mold 1 having a curved-surface recessed portion formed, the resin 2 is molded into a curved-surface protruding portion. The resin 2 may directly be filled in the mold 1, but a demolding agent may be coated over the mold 1 beforehand in order to improve demolding properties of the resin 2 from the mold 1 in a subsequent process. In this case, the resin 2 filled in the mold 1 is demolded from the mold 1 by separating the demolding agent and the resin 2, or by separating the demolding agent and the mold 1. Thus, the expression “demold the resin 2 from the mold 1” in the present specification means both separating the demolding agent coating the mold 1 from the resin 2, and separating the demolding agent coating the mold 1 from the mold 1.

The material of the mold used for the present embodiment is not restricted to a particular material, and metal, glass, resin, or the like can be employed, for example. Employing a material having high ultraviolet permeability as a mold material enables an ultraviolet hardening resin to be used as the resin 2, which can be hardened by irradiating an ultraviolet ray from the mold face side.

The resin 2 which can be employed in the present embodiment is not restricted to a particular resin, and an ultraviolet hardening resin, thermosetting resin, two-liquid curing resin, thermosoftening resin, and so forth, can be employed, for example. Other examples of resin material include acrylate, epoxy, polyester, polyolefine, polystyrene, polyurethane, polyimide, silicone rubber, and so forth, and copolymers or mixtures of these. Also, these resins 2 including filler such as silica or alumina can also be employed. Thus, in the case of a filler being included in the resin 2, the filler is regarded as a part of the resin 2. Since the resin structure portion will be used for manufacturing an X-ray shield grating, the X-ray transmittance of the resin 2 is preferably high. Note that the present first process to fill the resin 2 in the mold 1 is not restricted to filling the resin 2 in all of the recessed portions of the mold 1, and the mold 1 may include unfilled portions. The method for filling the resin 2 is not restricted to a particular method, and the resin 2 can be filled using a dispenser, dispensing burette, pipettor, or the like, for example.

### Second Process

Next, as illustrated in FIG. 1B, description will be made regarding the second process to fix a first supporting substrate 3 onto the resin 2 filled in the mold 1. Fixing between the resin 2 and the first supporting substrate 3 may be performed as follows. If prior to hardening of the resin 2, the first supporting substrate 3 is disposed on the resin 2 and thereafter the resin 2 is hardened. In this case, it is at the time of hardening the resin 2 that the first supporting substrate 3 is fixed onto the resin 2, and accordingly, the second process and third process are performed at the same time. If after hardening of the resin 2, for example, the first supporting substrate 3 can be fixed onto the resin 2 by disposing an adhesive between the resin 2 and the first supporting substrate 3. Note that disposing the first supporting substrate 3 on the resin 2 may be referred to as a preparation for the second process in the present specification. The first supporting substrate 3 is used for demolding from the mold 1 in a manner integral with the resin 2 molded by the mold 1. Also, in the case that hardening of the resin 2 involves an ultraviolet hardening resin serving using radical polymerization, oxygen in the atmosphere serves as a hardening inhibitor. In this case, the first supporting substrate 3 is disposed on the resin 2, whereby the resin surface can also be hardened by shielding contact between the resin surface and oxygen.

Employing a material having flexibility as the material of the first supporting substrate 3 is desirable, since damage does not easily occur when demolding, and demolding is more readily performed. For example, when the Young's modulus of the first supporting substrate 3 is equal to or smaller than 200 GPa, the first supporting substrate 3 is not readily damaged, and also the resin 2 is readily demolded at the time of demolding the resin 2. Specific examples of a metal material which can be employed include iron, aluminum, copper, and stainless steel. Specific examples of a resin material (serving as the material of the first supporting substrate 3) which can be used include acrylic, polyethylene, polycarbonate, epoxy, PEEK, and polyimide. In the case of employing an ultraviolet hardening resin as the resin 2 to be filled in the mold 1, a material which transmits ultraviolet rays is preferably employed as the material of the first supporting substrate 3. Examples of this include glass, acrylic, epoxy, and polyethylene terephthalate (PET). However, in the case that the material of the mold 1 is a material which transmits ultraviolet rays, a material other than a material which transmits ultraviolet rays may also be employed as the material of the first supporting substrate 3. When employing a material having high strength as the material of the first supporting substrate 3, disconformity between the shape of the resin structure and the shape of the mold 1 which is caused due to cure shrinkage can be reduced. Therefore, a material having strong strength is desirable as the material of the first supporting substrate 3, but the material of the first supporting substrate 3 can be decided as appropriate taking into consideration balance with the X-ray transmittance. Examples of a material which excels in X-ray properties and can be employed include glass, silicon, boron bromide, aluminum, acrylic, epoxy, polypropylene, polycarbonate, polyethylene, polyether ether ketone (PEEK), and polyimide.

Note that the first to third processes may be performed by dropping the resin 2 on the first supporting substrate 3 beforehand, filling the resin 2 in the mold 1, and then hardening this. Also, if the resin 2 is unhardened when disposing the first supporting substrate 3 on the resin 2, the shape of the resin 2 can be adjusted by pressing the first supporting substrate 3 against the resin 2.

### Third Process

Next, the third process (not illustrated) to harden the resin 2 filled in the mold 1 will be described. The present process may be performed at any timing from end of the first process until the fifth process is started. Hardening of the resin 2 may be performed in accordance with the material of the resin 2. For example, in the case of employing an ultraviolet hardening resin, ultraviolet rays should be irradiated on the resin, and in the case of employing a thermal hardening resin, heat should be applied to the resin.

### Fourth Process

Next, description will be made regarding the fourth process to fix a second supporting substrate onto the first supporting substrate 3.

Examples of a method for fixing the second supporting substrate onto the first supporting substrate 3 which can be employed include a method employing liquid, a method employing suctioning, and a method employing an adhesive having stimulus responsiveness. FIG. 1C illustrates the fourth process using the method employing liquid.

In the method employing liquid, a second supporting substrate 5 is disposed onto the first supporting substrate 3 via liquid 4, thereby fixing the second supporting substrate 5 onto the first supporting substrate 3 using surface tension of the liquid 4. A method for disposing the second supporting substrate 5 is to coat the liquid 4 over one or both of the first supporting substrate 3 and second supporting substrate 5, and to dispose the second supporting substrate 5 on the first supporting substrate 3. When fixing the first supporting substrate 3 and second supporting substrate 5 using the liquid 4, these members are not readily peeled off in the vertical direction as to mutual contact surfaces 6. On the other hand, both can readily be moved in the horizontal direction as to the mutual contact surfaces 6, and accordingly, the first supporting substrate 3 and second supporting substrate 5 can readily be separated in the later-described sixth process. Thus, in the case of fixing the first supporting substrate 3 and second supporting substrate 5 using surface tension of the liquid 4, water can be employed as the liquid 4, for example. In the case of employing water, water having high purity is not necessarily needed. Accordingly, purified water, ion-exchanged water, tap water, or the like can be employed. Note that liquids other than water can be employed for fixing, as long as the surface tension is sufficient for fixing between the first supporting substrate 3 and second supporting substrate 5. However, liquid which can readily be removed in the sixth process is preferably employed. Also, liquid which generates no chemical reaction as to the first supporting substrate 3 and second supporting substrate 5 is preferably employed. The first supporting substrate 3 and second supporting substrate 5 are preferably fixed by disposing the second supporting substrate 5 on the first supporting substrate 3 via the water, from these perspectives and ease of handling. Note that simple reference to “contact surfaces 6” in the present specification means both of the contact surface of the first supporting substrate 3 as to the second supporting substrate 5, and the contact surface of the second supporting substrate 5 as to the first supporting substrate 3.

In the method employing suctioning, the second supporting substrate 5 is disposed on the first supporting substrate 3 using a substrate where holes are provided, as the second supporting substrate 5, and gas existing between the first supporting substrate 3 and second supporting substrate 5 is suctioned from the second supporting substrate 5 side, thereby fixing the second supporting substrate 5 onto the first supporting substrate 3. Thus, pressure between the first supporting substrate 3 and second supporting substrate 5 goes is in a reduced state. In the case of employing this method, a vacuum chuck method can be employed, for example. After fixing the first supporting substrate 3 and second supporting substrate 5 using suctioning, when suctioning is stopped, the first supporting substrate 3 and second supporting substrate 5 can be separated, and accordingly, the later-described sixth process can readily be performed. However, suctioning facilities are needed in comparison with the method employing liquid.

The method employing an adhesive having stimulus responsiveness fixes the second supporting substrate 5 onto the first supporting substrate 3 using an adhesive of which the adhesive force changes according to stimulus. For example, in the case of employing an adhesive of which the adhesive force is weakened by stimulus of light or heat, stimulus is applied to the adhesive in the later-described sixth process, whereby the first supporting substrate 3 and second supporting substrate 5 can be separated. Conversely, in the case of employing an adhesive of which the adhesive force is strengthened by stimulus of light or heat, stimulus is applied to the adhesive during the later-described fifth process, and stimulus to the adhesive is stopped in the sixth process, whereby the first supporting substrate 3 and second supporting substrate 5 can be separated. At this time, a residue of the adhesive may remain on the first supporting substrate 3. In the case of employing the resin structure as an optical component or a part of an optical component, the residue of the adhesive may affect the performance of the optical component. Therefore, in the case there is residue remaining, the residue adhering to the first supporting substrate 3 is preferably removed by cleansing employing an organic solvent. At this time, the structure of the resin 2 may be dissolved depending on the organic solvent employed, and accordingly, cleansing is preferably performed after performing masking of the resin 2, or the like.

As described above, the second supporting substrate 5 is fixed onto the first supporting substrate 3, and accordingly, the first supporting substrate 3 is temporarily reinforced by the second supporting substrate 5, so bending strength of the first supporting substrate 3 can be improved.

### Fifth Process

Next, description will be made regarding the fifth process to demold the resin 2 from the mold 1 using the second supporting substrate 5 illustrated in FIG. 1D. Demolding the resin 2 from the mold 1 using the second supporting substrate 5 includes not only directly using the second supporting substrate 5 but also indirectly using the second supporting substrate 5. For example, in the case that the second supporting substrate 5 is smaller than the first supporting substrate 3, the resin 2 can be demolded from the mold 1 using the first supporting substrate 3. In this case, the second supporting substrate 5 is not directly used for demolding. However, force is applied to the second supporting substrate 5 via the first supporting substrate 3, and accordingly, the resin 2 is demolded from the mold 1 using the second supporting substrate 5 in this case as well. The demolding method is not restricted to a particular method. However, in the case of fixing the second supporting substrate 5 onto the first supporting substrate 3 using liquid 4 in the fourth process, this fixation is powerful against force in a direction perpendicular to the contact surfaces of the first supporting substrate 3 and second supporting substrate 5, and is weak against force in the horizontal direction. Therefore, demolding is preferably performed from an interface between the resin 2 and mold 1 while applying load to the contact surface 6 direction from a face opposite to the contact surface of the first supporting substrate 3 and a face opposite to the contact surface of the second supporting substrate 5. Thus, load is applied in the vertical direction as to the contact surfaces 6, and accordingly, the second supporting substrate 5 can be suppressed from moving in the horizontal direction as to the contact surfaces 6. Also, applying load brings the first supporting substrate 3 and second supporting substrate 5 tightly in contact with each other, so demolding can be made in a state in which bending strength of the first supporting substrate 3 is improved. As described above, the bending strength of the first supporting substrate 3 can be improved, so demolding can be performed with reduced risk of damage to the first supporting substrate 3 even when employing a thin substrate as the first supporting substrate 3. Examples of methods for applying load in the direction of the contact surfaces 6 include sandwiching the first supporting substrate 3 and second supporting substrate 5 using a clip, and pinching the first supporting substrate 3 and second supporting substrate 5 using the fingers.

### Sixth Process

Description will be made regarding the sixth process to separate the first supporting substrate 3 and second supporting substrate 5 illustrated in FIG. 1E. This process is performed after the resin 2 is demolded from the mold 1.

In the case of having fixed the second supporting substrate 5 onto the first supporting substrate 3 using the liquid 4 in the fourth process, the first supporting substrate 3 and second supporting substrate 5 are adhered by surface tension of the liquid 4 as described above, and accordingly, the second supporting substrate 5 can readily be moved in the horizontal direction as to the contact surfaces 6. When moving the first supporting substrate 3 in the horizontal direction as to the second supporting substrate 5, mutual contact areas are reduced, and the first supporting substrate 3 and second supporting substrate 5 can be separated. The liquid 4 adhering to the contact surface of the first supporting substrate 3 can be removed by natural drying, nitrogen blowing, or by being wiped.

In the case of having fixed the second supporting substrate 5 onto the first supporting substrate 3 using suctioning in the fourth process, the first supporting substrate 3 and second supporting substrate 5 can be separated by stopping the suctioning, as described above.

In the case of having fixed the second supporting substrate 5 onto the first supporting substrate 3 using an adhesive having stimulus responsiveness in the fourth process, the first supporting substrate 3 and second supporting substrate 5 can be separated by applying stimulus suitable for the employed adhesive, or by stopping appliance of stimulus. As described above, in the case where residue of the adhesive has adhered to the first supporting substrate 3, this residue is preferably removed.

According to the first to sixth processes, the resin structure where the resin 2 molded by the mold 1 is formed can be manufactured on the first supporting substrate 3. Using the second supporting substrate 5 enables the thickness of the first supporting substrate 3 to be reduced in comparison with the case where no second supporting substrate 5 is employed. Using the first to sixth processes according to the present embodiment enables a microlens, a diffraction optical element, and an antireflection structure to be formed on a thin substrate.

### Seventh Process

Next, description will be made regarding the seventh process to fix the metal structure portion to the resin 2 demolded from the mold 1 illustrated in FIG. 1E. The metal structure portion is fixed onto the resin 2 in the present embodiment. Note that “onto the resin 2” means onto a surface (onto the contact surface) of the resin 2 demolded from the mold 1, which had been in contact with the mold 1 when the resin 2 was filled in the mold 1. In the case of the present specification and in the present invention, a surface of the resin 2 demolded from the mold 1, which had been in contact with the mold 1 when the resin 2 was filled in the mold 1, will be referred to as “contact surface with the mold 1”. Also, in order to manufacture a structure which can be used as a shield grating, as described above, the metal structure portion according to the present embodiment includes the transmitting portions and shielding portions. A method for forming a metal structure portion on the resin 2 may be employed as a method for fixing the metal structure portion onto the resin 2, but a method for manufacturing a metal structure portion beforehand and fixing this onto the resin 2 is easier. A method for fixing a sheet-shaped metal structure portion 7 on the resin 2 may be employed as a method for fixing the metal structure portion onto the resin 2, for example. A method for applying an adhesive to a peripheral portion of the metal structure portion, and fixing this onto the resin 2 may be employed as a fixing method, for example (resin or adhesive tape may be employed instead of adhesive). The metal structure portion 7 is formed on the resin 2 having a spherical or curved-surface curved shape, whereby the metal structure portion 7 is curved following the contact surface shape of the resin 2 as to the mold 1.

Now, providing a through hole 8 to the metal structure portion 7 yields an arrangement where the direction of the through hole 8 is toward the normal direction as to the curved surface of the resin 2. Thus, fixing the metal structure portion 7 onto the resin 2 enables a structure including a resin structure portion and a metal structure portion to be manufactured. The metal structure portion 7 of this structure serves as an X-ray shielding portion, and the though hole 8 serves as an X-ray transmitting portion. Accordingly, this structure can be employed as the X-ray shield grating. The curved shape of the metal structure portion 7 is maintained by the resin 2, and mechanical strength can be improved in comparison with the metal structure portion 7 alone. Note that the metal structure portion 7 according to the present embodiment has a shape which can be employed as the X-ray shield grating. A plurality of holes are cyclically arrayed in this metal structure portion 7, and preferably have a cycle of between 1 μm and 13 μm, and height of between 10 μm and 300 μm. The aspect ratio is preferably 4.5 or higher, more preferably 10 or higher, and even more preferably 20 or higher.

Thus, the metal grating including the metal structure portion 7 having a curved shape has been manufactured by the first to seventh processes. In the case of employing the X-ray shield grating for imaging using an X-ray source which is a point light source, a resin having a curvature radius according to distance from the X-ray source is molded, and the metal structure portion 7 is fixed onto this resin. Thus, misalignment between the travelling direction of X-rays and the heights (thicknesses) of the shielding portions can be reduced, and accordingly, deterioration in the contrast of the X-ray which has transmitted through the X-ray shield grating can be reduced.

Further, the resin structure portion is made of a material having high X-ray transmittance, so X-ray transmission loss at an X-ray transmitting portion can be suppressed to a low level. Further, the metal structure portion 7 is fixed onto the hardened resin 2 at a structure 9 manufactured in the present embodiment, and accordingly, the resin 2 is not filled in the through holes 8 provided to the metal structure portion 7. Therefore, X-ray transmission loss at the X-ray transmitting portion due to the resin 2 being filled in the through holes 8 can also be suppressed.

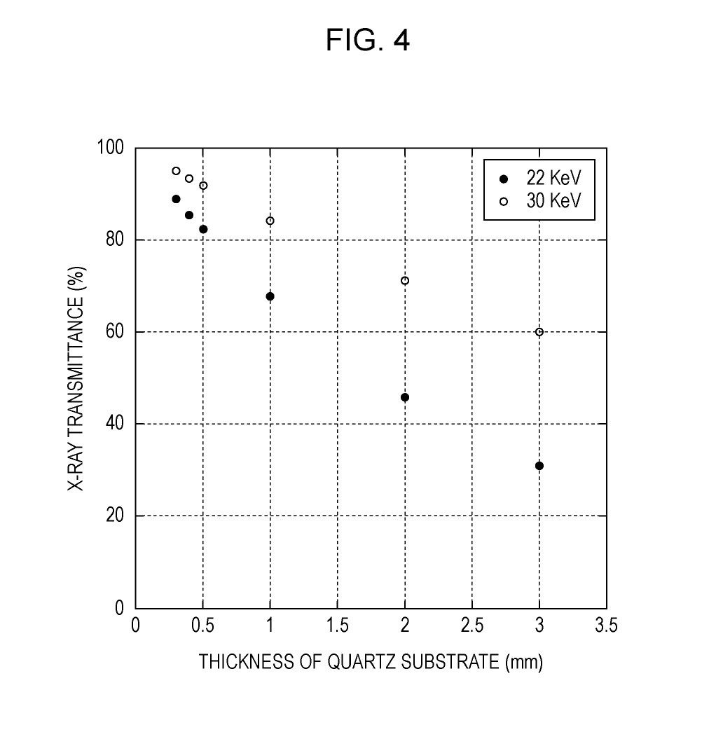

FIG. 4 is a graph illustrating the relationship between the thickness and X-ray transmittance of a quartz substrate, at each X-ray power. As can be understood from FIG. 4, in the case of employing a quartz substrate as the first supporting substrate 3, the X-ray transmittance decreases as the thickness of the quartz substrate increases. When employing the present embodiment, the first supporting substrate 3 can be made thinner, and accordingly, X-ray transmission loss due to the first supporting substrate 3 can also be reduced. Therefore, the structure 9 can be employed as an X-ray shield grating having high X-ray transmission contrast.

### Second Embodiment

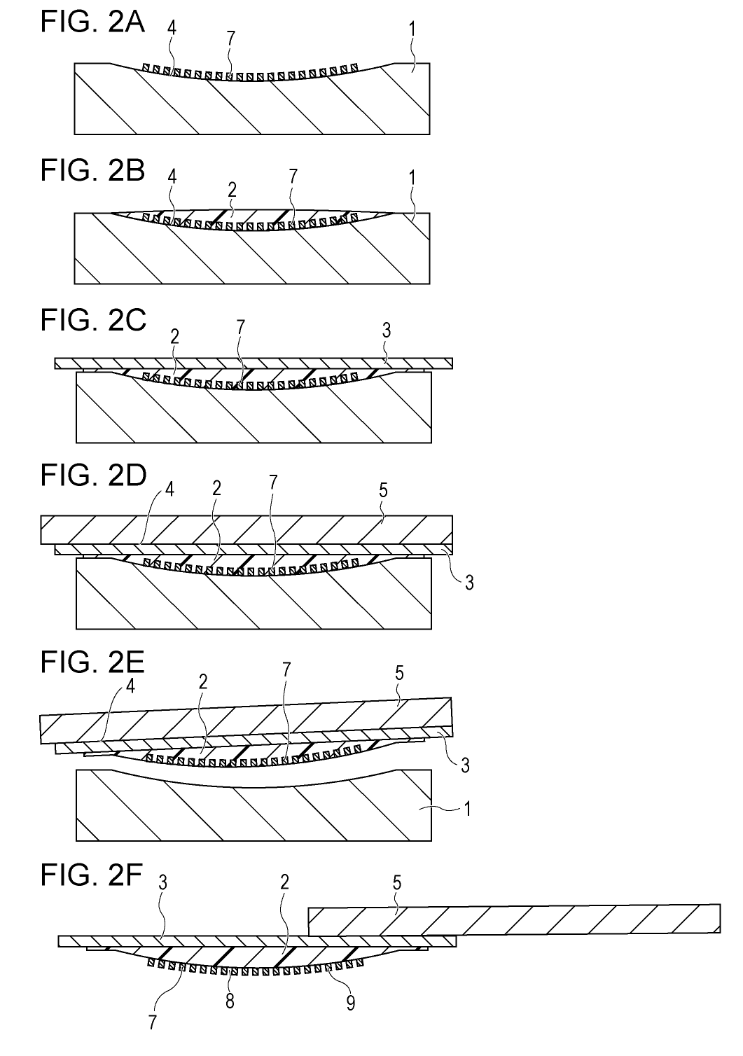

A second embodiment differs from the first embodiment in that the metal structure portion 7 is disposed in the mold 1 before the resin 2 is filled in the mold 1. The metal structure portion 7 is fixed within the resin 2 by filling the resin 2 in the mold 1 where the metal structure portion 7 is disposed, and hardening this resin 2. Note that, if at least a portion of the metal structure portion 7 is fixed within the resin 2, the metal structure portion 7 is regarded as being fixed within the resin 2. Also, according to the present embodiment, at the time of disposing the metal structure portion 7 in the mold 1, the metal structure portion 7 is disposed in the mold 1 via the liquid 4. Thus, the resin 2 can be filled in the mold 1 in a state in which the metal structure portion 7 is curved by surface tension, reflecting the shape of the mold 1. The present embodiment will be described with reference to FIG. 2.

A structure manufactured by the present embodiment can also be employed as the X-ray shield grating. An X-ray shield grating manufacturing method according to the present embodiment includes the following processes.
(1) This is a process to dispose the metal structure portion 7 in the mold 1 via the liquid 4, illustrated in FIG. 2A. The metal structure portion 7 is fixed to the mold 1 by surface tension of the liquid 4, and assumes a shape reflecting the shape of the mold 1. When employing the mold 1 where a spherical recessed portion is formed, the metal structure portion 7 is curved in a spherical shape, and when employing the mold 1 where a curved-surface recessed portion is formed, the metal structure portion 7 is curved in a curved surface shape.
(2) First Process: process to fill the resin 2 in the mold 1 illustrated in FIG. 2B. This process is the same as that in the first embodiment, and accordingly, details will be omitted, but the resin 2 is filled from above the metal structure portion 7 fixed to the mold 1, since the process in (1) is performed beforehand in the present embodiment. The metal structure portion 7 exists between the resin 2 and the mold 1, and accordingly, the contact area between the mold 1 and the resin 2 is small, and demolding properties between the resin 2 and the mold 1 are better than with the first embodiment.
(3) Second Process: process to fix the first supporting substrate 3 onto the resin 2 filled in the mold 1 illustrated in FIG. 2C. This process is the same as that in the first embodiment, and accordingly, details will be omitted.
(4) Third Process: process to harden the resin 2 filled in the mold 1 (not illustrated). This process is the same as that in the first embodiment, and accordingly, details will be omitted, but the metal structure portion 7 is fixed in the resin 2 by the process in (1) and the third process. Specifically, the seventh process to fix the metal structure portion 7 to the resin 2 is carried out in the present embodiment by performing the process in (1) and the third process.
(5) Fourth Process: process to dispose the second supporting substrate 5 on the first supporting substrate 3 illustrated in FIG. 2D. This process is the same as that in the first embodiment, and accordingly, details will be omitted.
(6) Fifth Process: process to demold the resin 2 from the mold 1 using the second supporting substrate 5 illustrated in FIG. 2E. This process is the same as that in the first embodiment, and accordingly, details will be omitted.
(7) Sixth Process: process to separate the first supporting substrate 3 and second supporting substrate 5 after demolding illustrated in FIG. 2F. This process is the same as that in the first embodiment, and accordingly, details will be omitted.

Note that the processes illustrated in (1) to (7) may be performed without being restricted to this order. For example, the third process to harden the resin 2 illustrated in (4) has to be performed prior to the fifth process to demold the resin 2 from the mold 1, but may be performed after the fourth process illustrated in (5), or may be performed prior to the second process illustrated in (3). Also, the process illustrated in (1) may be performed after the first process illustrated in (2). In this case, the process illustrated in (1) is performed so as to sink the metal structure portion 7 in the resin 2 filled in the mold 1. However, performing the process illustrated in (1) beforehand yields better demolding properties between the resin 2 and the mold 1, and also, the metal structure portion 7 can readily be curved along the shape of the mold 1.

### Third Embodiment

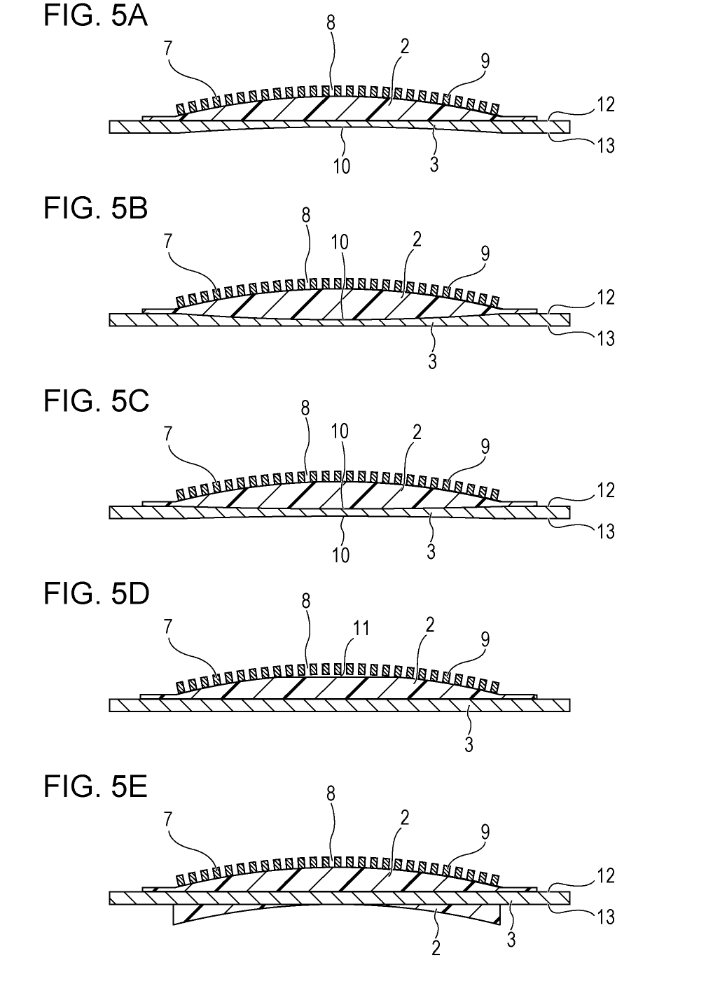

Embodiments other than FIGS. 1F and 2F will be described in a third embodiment regarding the structure 9 manufactured by the first embodiment or second embodiment, with reference to FIGS. 5A to 5E. In FIGS. 1F and 2F, the thickness of the resin structure portion is smaller the farther from the center and closer to around the outer circumference. Therefore, in the case of employing the structure 9 as the X-ray shield grating, transmittance distribution occurs at the X-ray transmitting portion derived from the thickness of the resin structure portion. The structure 9 according to the present embodiment has reduced transmittance distribution of the X-ray transmitting portion in comparison with the structures in FIGS. 1F and 2F. The structure 9 according to the present embodiment also includes, in the same way as with the structures in FIGS. 1F and 2F, a resin structure portion including a supporting substrate and a resin provided to the supporting substrate, and a metal structure portion provided to the resin. Also, of the supporting substrate, the surface where the resin structure portion is provided will be referred to as “first surface”, and the surface opposite to the first surface will be referred to as “second surface”.

The structures 9 in FIGS. 5A to 5C are configured so that the thickness of the resin structure portion on the first supporting substrate 3 is greater toward the center, and on the other hand, the thickness of the first supporting substrate 3 is smaller toward the center. That is to say, the thickness of the first supporting substrate 3 is smaller in a region where the thickness of the resin 2 provided onto the first supporting substrate 3 is greater, in-plane of the structures 9. Thus, the combined X-ray transmittance distribution of the resin structure portion and the first supporting substrate 3 is smaller, and accordingly, the contrast of transmittance distribution of the X-ray transmitting portion is smaller. For example, let us say that, of the structure 9, optional regions are taken as a first region and a second region. At this time, if we say that the thickness of the resin structure portion in the second region is thicker than the thickness of the resin structure portion in the first region, the thickness of the resin structure portion in the second region is made smaller in comparison with the thickness of the supporting substrate 3 in the first region. Thus, difference in X-ray transmittance between the X-ray transmitting portion in the first region and the X-ray transmitting portion in the second region can be reduced.

According to the structure 9 in FIG. 5A, a recessed portion 10 is provided to a surface (second surface 13) opposite to a surface where the resin structure portion of the first supporting substrate 3 (first surface 12). The region where the recessed portion 10 is provided and the region where the resin structure portion is provided preferably face to each other, and the shape of the recessed portion 10 and the shape of the resin structure portion preferably have a complementary relationship. On the other hand, according to the structure 9 in FIG. 5B, the recessed portion 10 is formed on the first surface 12 of the first supporting substrate 3. According to the structure 9 in FIG. 5C, the recessed portion 10 is formed on both surfaces of the first surface 12 and second surface 13 of the first supporting substrate 3.

According to the structures 9 in FIGS. 5A to 5C, the thickness of the first supporting substrate 3 of the region where the thickness of the resin structure portion is thicker is thinner, and accordingly, the transmittance distribution of the X-ray transmitting portion can be reduced. Also, though the transmittance deteriorates in the region where the thickness of the resin structure portion is thicker, the transmittance of the X-ray transmitting portion can be improved by reducing the thickness of the first supporting substrate 3. Adjusting the depth of the recessed portion 10 taking into consideration the thickness of the resin structure portion enables employing as an X-ray shield grating having a smaller transmittance distribution.

Next, the embodiment in FIG. 5D will be described. According to the structure 9 in FIG. 5D, an air gap 11 is formed in a portion between the resin structure portion provided onto the first supporting substrate 3 and the metal structure portion 7 provided onto the resin structure portion. The thickness of the resin structure portion is smaller by an amount equivalent to the air gap 11 that has been formed, in comparison with FIGS. 1F and 2F. Accordingly, an X-ray shield grating is formed wherein transmission loss due to the resin structure portion equivalent to the air gap 11 is smaller, and the X-ray transmittance of the X-ray transmitting portion is high in comparison with FIGS. 1F and 2F. Further, difference in thickness of the resin structure portion between at the center and at around the outer circumference can be reduced, and accordingly, the transmittance distribution of the X-ray transmitting portion of the X-ray shield grating can be reduced. Note that an air gap is preferably provided in at least a region where the thickness of the resin structure portion is the thickest when providing no air gap (the center of the resin structure portion in FIG. 5D). The region where the thickness of the resin structure portion is the thickest when providing no air gap agrees with a region where distance between the metal structure portion 7 and the first supporting substrate 3 is the longest.

Next, the embodiment in FIG. 5E will be described. The structure 9 in FIG. 5E includes the first supporting substrate 3, a protruding resin structure portion provided to the first surface 12 of the first supporting substrate 3, and a recessed resin structure portion provided to the second surface 13 opposite to the first surface. The metal structure portion 7 is provided to one of the resin structure portions.

An arrangement is made so as to equalize curvatures of the protruding resin structure portion and recessed resin structure portion, and also so that a line segment which connects the centers of the curvatures and the first supporting substrate 3 vertically intersect. Thus, the thickness of the resin structure portion provided to the first surface 12 and the thickness of the resin structure portion provided to the second surface 13 are equalized. In the case of employing this structure 9 as the X-ray shield grating, difference in the thickness of the total resin structure portion between at the center and at around the outer circumference is reduced. Accordingly, this structure 9 is an X-ray shield grating of which the X-ray transmitting portion has a small transmittance distribution. The recessed resin structure portion according to the present embodiment, provided to the second surface 13, may be made as follows. This recessed resin structure portion may be made up of the recessed resin structure portion formed on the first supporting substrate 3 in the first process to sixth process in the first embodiment, and the protruding resin structure portion formed on the first supporting substrate 3, being adhered to each other at the non-resin structure portion forming surfaces of each other. In this case, the first supporting substrate 3 is configured of the two sheets. Also, while the protruding resin structure portion is provided to the first surface 12 and the recessed resin structure portion is provided to the second surface 13 in FIG. 5E, an arrangement may be made wherein the recessed resin structure portion is provided to the first surface 12, and the protruding resin structure portion is provided to the second surface 13. Providing the recessed resin structure portion to the first surface 12 gives the structure 9 a shape so that the metal structure portion 7 is supported within the recessed portion. Hereinafter, the embodiments will be described in more detail with reference to specific exemplary embodiments.

### First Exemplary Embodiment

An exemplary embodiment of the first embodiment will be described. The present exemplary embodiment employs a recessed mold having a spherical shape with a radius of 1.6 m as the mold 1, a quartz substrate having a thickness of 0.5 mm as the first supporting substrate 3, a tempax glass substrate having a thickness of 3.2 mm as the second supporting substrate 5, and a meshed two-dimensional shield grating made of metal as the metal structure portion 7. Also, the first supporting substrate 3 and the second supporting substrate 5 are fixed using water in the fourth process. Fixing of the first supporting substrate 3 in the second process is performed by fixing the resin 2 in the third process. Hereinafter, the present exemplary embodiment will be described with reference to FIGS. 1A to 1F.

The mold 1 used for the present exemplary embodiment has a spherical recessed face of which the curvature radius is 1.6 m formed in a region of 130 mm in diameter. The surface of this recessed face of the mold 1 is an electroless nickel plating layer. An ultraviolet hardening resin (TB3114 manufactured by Three Bond Co., Ltd.) is dropped and filled in the recessed face of the mold 1 as the resin 2 (FIG. 1A, first process). Next, a quartz substrate having a thickness of 0.5 mm is employed as the first supporting substrate 3, and this substrate is pressed from above the ultraviolet hardening resin. Thus, the first supporting substrate 3 is disposed on the filled resin (FIG. 1B, preparation for the second process). Next, an ultraviolet lamp is irradiated on the ultraviolet hardening resin to harden the ultraviolet hardening resin (not illustrated, third process). Thus, the first supporting substrate 3 is fixed onto the resin 2 (second process). Next, water is applied to the first supporting substrate 3 as the liquid 4, and the second supporting substrate 5 is disposed on the first supporting substrate 3 via the water. Thus, the first supporting substrate 3 and second supporting substrate 5 are fixed by surface tension of the water (FIG. 1C, fourth process). Next, the ultraviolet hardening resin is demolded from the mold 1 while pinching the surface of the first supporting substrate 3 opposite to the contact surface and the surface of the second supporting substrate 5 opposite to the contact surface using the fingers (FIG. 1D, fifth process). Thus, the ultraviolet hardening resin can be demolded from an interface with the mold 1 while preventing damage of the first supporting substrate 3. The surface shape of the ultraviolet hardening resin obtained by being demolded from the mold 1 has a shape reflecting the spherical shape of the mold 1. Next, the second supporting substrate 5 is shifted in parallel with the contact surface of the first supporting substrate 3 (FIG. 1E) to separate the first supporting substrate 3 and second supporting substrate 5 (sixth process). Next, a sheet made of gold is prepared as the metal structure portion 7. This sheet has a thickness of 120 μm, and 4-μm diameter through holes 8 are two-dimensionally arrayed with a pitch of 8 μm. This sheet made of gold has a size of 130 mm in diameter, and can serve as the X-ray shield grating. Water is applied onto the resin having a spherical shape of the resin structure portion, and the metal structure portion 7 is disposed on the resin 2. The metal structure portion 7 adheres to the spherical shape of the resin 2 by surface tension. An ultraviolet hardening resin (TB3114 manufactured by Three Bond Co., Ltd.) is applied to the circumference of the metal structure portion 7 adhered to the spherical shape of the resin 2, and the ultraviolet hardening resin is hardened by irradiating the ultraviolet lamp thereon, whereby the metal structure portion 7 is fixed to the structure of the resin 2 (FIG. 1F, seventh process). Thus, the structure 9 including the curved metal structure portion 7 is obtained. The through holes 8 of the metal structure portion 7 are directed in the normal direction as to the spherical surface of the resin 2. In the case of employing the structure 9 manufactured by the present exemplary embodiment as the X-ray shield grating, the transmittance of the X-ray transmitting portion under 22 KeV X-ray power is around 77% at the center of the X-ray shield grating, around 83% in the vicinity of the outer circumference, and the shield factor of the X-ray shielding portion is equal to or higher than 99.9%.

### First Comparative Example

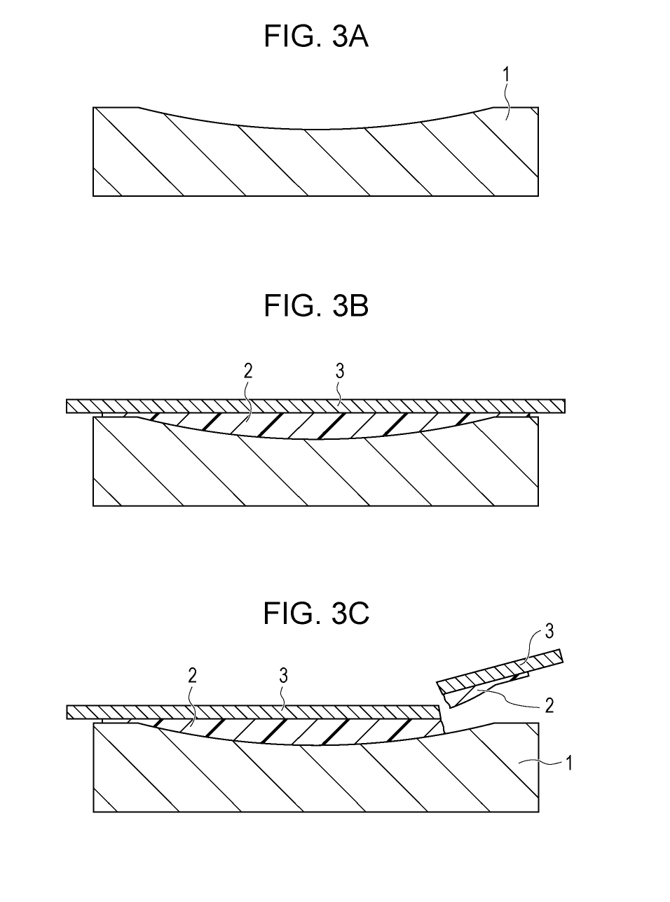

This comparative example is carried out in the same way as with the first exemplary embodiment except that the ultraviolet hardening resin is demolded from the mold 1 without employing the second supporting substrate 5. Demolding the ultraviolet hardening resin from the mold 1 while holding the first supporting substrate 3 damages the first supporting substrate 3 such as illustrated in FIG. 3, so it is difficult to demold the resin 2 from the mold 1.

### Second Exemplary Embodiment

An exemplary embodiment of the second embodiment will be described.

The present exemplary embodiment employs the same mold 1, second supporting substrate 5 and metal structure portion 7 as with the first exemplary embodiment. A quartz substrate having a thickness of 0.4 mm is employed as the first supporting substrate 3. Also, the first supporting substrate 3 and second supporting substrate 5 are fixed using water in the fourth process, in the same way as with the first exemplary embodiment. The present exemplary embodiment differs from the first exemplary embodiment in that the second and third processes are performed after the fourth process, and in that the metal structure portion 7 is fixed to the mold 1 before dropping of the resin 2, using surface tension of the water. Hereinafter, the present exemplary embodiment will be described with reference to FIGS. 2A to 2F.

Upon water being applied to the surface of the mold 1 as the liquid 4, and a sheet made of gold being disposed thereon as the metal structure portion 7, the sheet of the metal structure portion 7 adheres to the recessed spherical surface of the mold 1 by surface tension of the water, and is fixed (FIG. 2A). Next, an ultraviolet hardening resin (TB3114 manufactured by Three Bond Co., Ltd.) is dropped from above the sheet of the metal structure portion 7 fixed to the recessed spherical surface of the mold 1, and is filled therein as the resin 2 (FIG. 2B, first process). A quartz substrate having a thickness of 0.4 mm is employed as the first supporting substrate 3. This substrate is pressed from above the ultraviolet hardening resin. Thus, the first supporting substrate 3 is disposed on the filled resin 2 (FIG. 2C, preparation for the second process). Next, water is applied onto the first supporting substrate 3 as the liquid 4, and the second supporting substrate 5 is disposed on the first supporting substrate 3 via the water. Thus, the first supporting substrate 3 and the second supporting substrate 5 are fixed by surface tension of the water (FIG. 2D, fourth process). Next, the ultraviolet hardening resin is hardened by irradiating the ultraviolet lamp thereon (not illustrated, third process). Thus, the first supporting substrate 3 is fixed onto the resin 2 (second process). Next, the ultraviolet hardening resin to which the metal structure portion is fixed is demolded from the mold 1 while pinching the surface of the first supporting substrate 3 opposite to the contact surface and the surface of the second supporting substrate 5 opposite to the contact surface using the fingers (FIG. 2E, fifth process). Thus, the ultraviolet hardening resin can be demolded from the interface with the mold 1 while preventing damage of the first supporting substrate 3. The surface shape of the ultraviolet hardening resin obtained by being demolded from the mold 1 has a shape on which the spherical shape of the mold 1 is reflected. Next, the second supporting substrate 5 is shifted in parallel with the contact surface 6 of the first supporting substrate 3 (FIG. 2F) to separate the first supporting substrate 3 and second supporting substrate 5 (sixth process). In the present exemplary embodiment, the seventh process is carried out by performing the process in FIG. 2A and the third process. Thus, the structure 9 including the resin structure portion and the curved metal structure portion 7 is obtained. The through holes 8 of the metal structure portion 7 are directed in the normal direction as to the spherical surface that the resin 2 has. In the case of employing the structure 9 manufactured by the present exemplary embodiment as the X-ray shield grating, the transmittance of the X-ray transmitting portion at 22 KeV X-ray power is around 80% at the center of the X-ray shield grating, around 90% in the vicinity of the outer circumference, and the shield factor of the X-ray shielding portion is equal to or higher than 99.9%.

The present exemplary embodiment employs the second embodiment, and accordingly, the resin 2 is also filled in the through holes 8 of the metal structure portion 7, unlike the case of employing the first embodiment. Therefore, in the case of employing the same first supporting substrate 3 as with the first embodiment, the transmittance of the X-ray transmitting portion deteriorates by an amount equivalent to occurrence of X-ray absorption due to the resin 2 being filled in the through holes 8. However, demolding properties between the mold 1 and the resin 2 improve in comparison with the case of employing the first embodiment. Accordingly, a substrate thinner than the first supporting substrate 3 used for the first embodiment, that is, a substrate having high X-ray transmittance, can be employed as the first supporting substrate 3. Therefore, the transmittance of the X-ray transmitting portion may be improved.

The structures manufactured employing the first and second embodiments can be employed as X-ray shield gratings used for the X-ray Talbot interference method. An X-ray imaging apparatus configured to perform the X-ray Talbot interference method includes a diffraction grating configured to diffract a spatially coherent divergent X-ray to form an interference pattern, an X-ray shield grating configured to shield a portion of X-rays to form an interference pattern, and a detector configured to detect X-rays from the X-ray shield grating. The shield grating is disposed so that distance with the diffraction grating is equal to Talbot distance, whereby a portion of X-rays to form an interference pattern can be shielded.

### Third Exemplary Embodiment

An exemplary embodiment of the third embodiment will be described with reference to FIG. 5A.

A protruding spherical resin structure portion with a 1.6-m curvature radius of the structure 9 according to the present exemplary embodiment is formed in a 130-mm diameter region of the first surface 12 of the first supporting substrate 3. The metal structure portion 7 on the resin structure portion is made of gold, and has a thickness of 120 μm. 4-μm diameter through holes 8 are two-dimensionally arrayed at an 8-μm pitch.

The first supporting substrate 3 is a 0.5-mm quartz substrate. The spherical recessed portion 10 with a 14-m curvature radius is formed in a 130-mm diameter region of the second surface 13 of the first supporting substrate 3 opposite to the first surface 12 of the first supporting substrate 3. The thickness of the center of the first supporting substrate 3 where the quartz substrate is the thinnest is around 0.35 mm. In the case of employing the structure 9 according to the present exemplary embodiment as the X-ray shield grating, the transmittance of the X-ray transmitting portion at 22 KeV X-ray power is around 83% at the center of the X-ray shield grating, around 83% in the vicinity of the outer circumference, and the shield factor of the X-ray shielding portion is equal to or higher than 99.9%.

### Fourth Exemplary Embodiment

An exemplary embodiment of the third embodiment will be described with reference to FIG. 5D.

A protruding spherical resin structure portion with a 1.6-m curvature radius of the structure 9 according to the present exemplary embodiment is formed in a 130-mm diameter region of one of the surfaces of the first supporting substrate 3. The protruding surface of the center of the resin structure portion is flat within a 20-mm diameter region from the center of the resin structure portion, and has no curvature. The metal structure portion 7 on the resin structure portion is made of gold, and has a thickness of 120 μm, and 4-μm diameter through holes 8 are two-dimensionally arrayed at an 8-μm pitch. The resin structure portion is not in contact with the metal structure portion 7 in the 20-mm diameter region from the center of the resin structure portion, where the air gap 11 exists. The first supporting substrate 3 is a quartz substrate with a thickness of 0.5 mm. In the case of employing the structure 9 according to the present exemplary embodiment as the X-ray shield grating, the transmittance of the X-ray transmitting portion at 22 KeV X-ray power is around 81% at the center of the X-ray shield grating, around 83% in the vicinity of the outer circumference, and the shield factor of the X-ray shielding portion is equal to or higher than 99.9%.

### Fifth Exemplary Embodiment

An exemplary embodiment of the third embodiment will be described with reference to FIG. 5E.

A resin structure portion having a spherical recessed surface with a 1.6-m curvature radius of the structure 9 according to the present exemplary embodiment is formed in a 130-mm diameter region of the second surface 13 of the first supporting substrate 3. The metal structure portion 7 on the resin structure portion is made of gold, and has a thickness of 120 μm. 4-μm diameter through holes 8 are two-dimensionally arrayed at an 8-μm pitch. In the case of employing the structure 9 according to the present exemplary embodiment as the X-ray shield grating, the transmittance of the X-ray transmitting portion at 22 KeV X-ray power is around 77% at the center of the X-ray shield grating, around 77% in the vicinity of the outer circumference, and the shield factor of the X-ray shielding portion is equal to or higher than 99.9%.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-284433, filed Dec. 27, 2012, and Japanese Patent Application No. 2013-212296, filed Oct. 9, 2013, which are hereby incorporated by reference herein in their entirety.

What is claimed is:

1. A resin structure manufacturing method comprising:
filling a mold with a resin;
fixing a first supporting substrate onto the resin filled in the mold;
hardening the resin filled in the mold;
fixing a second supporting substrate onto the first supporting substrate;
demolding the resin from the mold using the second supporting substrate; and
separating the first supporting substrate and the second supporting substrate after the demolding.

2. The resin structure manufacturing method according claim 1,
wherein, in the step of fixing the second supporting substrate, the second supporting substrate is fixed onto the first supporting substrate by disposing the second supporting substrate on the first supporting substrate via a liquid.

3. The resin structure manufacturing method according claim 2,
wherein the liquid is water.

4. The resin structure manufacturing method according claim 1,
wherein, in the step of fixing the second supporting substrate, the second supporting substrate is fixed on the first supporting substrate by suctioning the first supporting substrate from the second supporting substrate.

5. The resin structure manufacturing method according claim 1,
wherein, in the step of fixing the second supporting substrate, the second supporting substrate is fixed onto the first supporting substrate by disposing the second supporting substrate on the first supporting substrate via an adhesive,
and wherein adhesive strength of the adhesive changes according to stimuli.

6. The resin structure manufacturing method according claim 1,
wherein the second supporting substrate has stronger bending strength than the bending strength of the first supporting substrate.

7. A structure manufacturing method comprising:
filling a mold with a resin;
fixing a first supporting substrate onto the resin filled in the mold;
hardening the resin filled in the mold;
fixing a second supporting substrate onto the first supporting substrate;
demolding the resin from the mold using the second supporting substrate;
separating the first supporting substrate and the second supporting substrate after demolding; and
fixing a metal structure portion to the resin.

8. The structure manufacturing method according claim 7,
wherein, in the step of fixing the metal structure portion, the metal structure portion is fixed onto a contact surface with the mold of the resin demolded from the mold.

9. The structure manufacturing method according claim 7,
wherein, in the step of fixing the metal structure portion, the metal structure portion is fixed within the resin.

10. The structure manufacturing method according claim 9,
wherein the step of filling is performed by filling the resin in the mold where the metal structure portion is disposed.

11. The structure manufacturing method according claim 10,
wherein the metal structure portion is disposed on the mold via a liquid.

12. The structure manufacturing method according claim 7,
wherein the metal structure portion is an X-ray shield grating.

13. A structure comprising:
a resin structure portion including:
a supporting substrate; and
a resin provided to a first surface of the supporting substrate; and
a metal structure portion provided to the resin.

14. The structure according to claim 13,
wherein the resin structure portion and the metal structure portion have a curved shape.

15. The structure according to claim 13,
wherein the metal structure portion includes an X-ray shield grating.

16. The structure according to claim 13, further comprising:
a first region; and
a second region,
wherein a thickness of the resin structure portion in the second region is greater than a thickness of the resin structure portion in the first region, and the thickness of the resin structure portion in the second region is smaller than a thickness of the supporting substrate in the first region.

17. The structure according to claim 13,
wherein an air gap is provided between the resin structure portion and the metal structure portion in a region having the longest distance between the metal structure portion and the supporting substrate.

18. The structure according to claim 13,
wherein the supporting substrate has a second surface opposite to the first surface,
wherein a resin structure portion is provided to the second surface,
wherein the resin structure portion provided to the first surface has a protruding shape,
and wherein the resin structure portion provided to the second surface has a recessed shape.

19. The structure according to claim 13,
wherein the supporting substrate has a second surface opposite to the first surface,
wherein a resin structure portion is provided to the second surface,
wherein the resin structure portion provided to the first surface has a recessed shape,
and wherein the resin structure portion provided to the second surface has a protruding shape.

20. An X-ray imaging apparatus comprising:
a diffraction grating configured to diffract a spatially coherent divergent X-ray to form an interference pattern;
an X-ray shield grating configured to shield a part of an X-ray forming the interference pattern; and
a detector configured to detect the X-ray from the X-ray shield grating,
wherein the X-ray shield grating is the structure according to claim 13.
